(19) United States
(12) Patent Application Publication
(10) Pub. No.: US 2011/0064359 A1
(43) Pub. Date: Mar. 17, 2011

(54) COMPACT OPTICAL FIBRE COMPONENT PACKAGE

(75) Inventors: Bengt Sahlgren, Saltsjo-boo (SE); Ola Holgersson, Bromma (SE)

(73) Assignee: PROXIMION FIBER SYSTEMS AB, Kista (SE)

(21) Appl. No.: 12/989,288

(22) PCT Filed: Apr. 25, 2008
(86) PCT No.: PCT/EP08/03375

§ 371 Date: Nov. 29, 2010

(51) Int. Cl. G02B 6/34

(52) U.S. Cl. 385/37

(57) ABSTRACT

The present invention relates to an optical component, which comprises an optical fibre, which has a minimal functional arc radius in each point thereof, and which includes a thermally compensated portion, and a Bragg grating provided in a region of the thermally compensated portion. The optical fibre component comprises furthermore a temperature-compensating structure, which holds the thermally compensated portion of the optical fibre under tension in a linear direction for athermalizing the Bragg grating, and a housing for mechanical protection of the Bragg grating, which is provided with at least a first lead-through, and which housing has a maximal extension in the linear direction from a first housing end to a second housing end. The first lead-through has an exit end located outside the housing and an entrance end located inside the housing. The optical fibre furthermore includes at least a first connecting portion, which extends from a first end of the thermally compensated portion to and through the first lead-through, and at least a first exit portion which extends from a lead-through exit end of the first connecting portion. The first lead-through is located and arranged such that the first exit portion is bendable to the minimal functional arc radius without protruding more than half the minimal functional arc radius in the linear direction beyond the first housing, also when a shorter exit portion is extended to a length equal to the circumference of a circle with the minimal functional arc radius.

### TECHNICAL FIELD OF THE INVENTION

The present invention relates to an optical fibre component, comprising an optical fibre provided with a Bragg grating in a region thereof, a temperature-compensating structure for athermalizing the Bragg grating and a housing for mechanical protection of the Bragg grating, which housing is provided with at least a first lead-through for the optical fibre.

### BACKGROUND ART

Temperature compensated fibre gratings such as fibre Bragg gratings, are well known optical fibre components and common in optical communication systems.

One example of providing a Bragg grating in an optical fibre is to expose a section of the optical fibre to an ultraviolet interference pattern. The ultraviolet light induces a permanent repetitive modulation of the refractive index of the core of the fibre. This modulation selectively reflects light of a resonance wavelength, λ_{B}, which satisfies

λ_{B}=2n_{eff}Λ,

where n_{eff} is the effective refractive index and Λ is the grating period. The remaining wavelengths pass the grating essentially unaffected.

The sharp reflection peaks make Bragg gratings suitable as, e.g., add/drop components for use in wavelength division multiplexed systems. Chirped gratings, in which the Bragg wavelength varies along the grating, are used as, e.g., dispersion compensators.

However, both Λ and n_{eff} vary according to environmental conditions, which results in the Bragg wavelength being dependent on ambient temperature and applied strain. Since it in many applications is desired to maintain a constant Bragg wavelength, several methods for compensating changing ambient conditions are known.

One method to compensate for temperature dependency of the Bragg grating is to change the tension of the grating in response to a temperature change such that the refractive index changes, which are induced by changes in temperature and tension, effectively cancel each other. This can be achieved by attaching the optical fibre to a structure, which comprises a plurality of materials with different coefficients of thermal expansion. The materials are assembled such that the combined structure effectively has a negative coefficient of thermal expansion between the two fibre attachment points. Examples of such methods are disclosed in U.S. Pat. No. 6,510,272 and U.S. Pat. No. 6,430,350.

Normally, a temperature compensated Bragg grating is enclosed in a housing, in which the Bragg grating is protected from the environment, especially with respect to mechanical damage and moisture. It is also known to include the housing in the structure as one of the materials with different coefficients of thermal expansion, which is described in, e.g., G. W. Yoffe, P. A. Krug, F. Ouellette, and D. A. Thorncraft, “Passive temperature-compensating package for optical fibre gratings”, Appl. Optics, Vol. 34, No. 30, Oct. 1995, pp. 6859-6861.

Optical fibre components of the above described athermal type are often used as subcomponents in optical modules which are mounted in rack systems. A problem when designing optical components for this purpose is rigid restrictions with respect to outer physical dimensions of the components in order for the component to fit in the rack. The aim to design such athermal optical fibre components as compact as possible, is often adversely affected by several other important design criteria imposed on the components. It is for example in many applications advantageous to use as long Bragg gratings as possible, and the athermal structures for thermal compensation of the Bragg gratings need a certain length for providing the desired compensating effect. Thus, the athermal structure contributes even further to the total length of the optical component.

### SUMMARY OF THE INVENTION

It is therefore an object of the present invention to provide an optical fibre component of the above-mentioned kind, which has a shorter mounting length than prior art components while still complying with other design criteria.

This object is achieved with an optical component according to the invention, which comprises an optical fibre, which has a minimal functional arc radius in each point thereof, and which includes a thermally compensated portion, and a Bragg grating provided in a region of the thermally compensated portion. The optical fibre component comprises furthermore a temperature-compensating structure, which holds the thermally compensated portion of the optical fibre under tension in a linear direction for athermalizing the Bragg grating, and a housing for mechanical protection of the Bragg grating, which is provided with at least a first lead-through, and which housing has a maximal extension in the linear direction from a first housing end to a second housing end. The first lead-through has an exit end located outside the housing and an entrance end located inside the housing. The optical fibre furthermore includes at least a first connecting portion, which extends from a first end of the thermally compensated portion to and through the first lead-through, and at least a first exit portion which extends from a lead-through exit end of the first connecting portion. The first lead-through is located and arranged such that the first exit portion is bendable to the minimal functional arc radius without protruding more than half the minimal functional arc radius in the linear direction beyond the first housing, also when a shorter exit portion is extended to a length equal to the circumference of a circle with the minimal functional arc radius.

In contrast to the optical fibre component according to the invention, prior art components are normally provided with a lead-through that is positioned in an end wall of the component housing and that is such arranged that the fibre exits the housing substantially in the linear direction. In optical modules or rack systems, which comprise several components, the optical components are often arranged side by side in columns. Thus, when a prior art component of that type is to be connected to another component in the same column, the fibre of the prior art component, which fibre exits the end wall in the linear direction, has to be bent around in a loop in order to meet the end wall of the intended component in the column. The fibre is thus bent away from the housing, whereby an addition corresponding to the bending radius of the fibre is added to the total length of the housing. The minimal addition of the fibre of the prior art component is caused when the exit portion of the fibre is bent as much as possible, i.e. to the minimal functional arc radius. Since the exit portion of the prior art fibre exits the housing in the linear direction, the minimal contribution of the exit portion to the total mounting length of the prior art component is equal to the length of the minimal functional arc radius. Normally, the exit portion contributes even more, due to the length of a lead-through located in the housing wall for guiding the fibre through the housing wall. Lead-throughs often include tension-relieving sleeves and/or protective sleeves, which can extend considerably from the housing wall.

Traditionally, in order to reduce the required space of a component in a module or a rack, the aim has been to reduce the total mounting length of the component by reducing the length of the housing, for example by trying to minimize the length of the Bragg grating or by minimizing the length of the temperature-compensating structure.

However, an understanding underlying the present invention is that the total mounting length of an optical fibre component is the sum of the length of the housing, including the temperature-compensating structure, and the length of the bending radius of an exit fibre, which radius length is introduced when the exit fibre is directed away from the housing in order to connect the component to other components.

Thus, according to the invention, a shorter total mounting length of the optical fibre component is achieved by reducing the contribution of at least a first exit portion of an optical fibre to the total mounting length of the optical component. According to the invention, this is implemented by locating the first lead-through in a suitable position in the housing and by arranging the first lead-through suitably, for example with respect to its angle relative the linear direction.

According to the invention, the first lead-through is located and arranged such that the first exit portion is bendable to the minimal functional arc radius without protruding more than half the minimal functional arc radius in the linear direction beyond the first housing end, also when a shorter exit portion is extended to a length equal to the circumference of a circle with the minimal functional arc radius. Thus, a short exit portion, which for example is shorter than half the minimal functional arc radius, and which thus protrudes less than half the minimal functional arc radius even if held straight in the linear direction, shall for the purposes of this invention be considered as if it had a minimal length corresponding to the circumference of a circle with the minimal functional arc radius. While lead-throughs in prior art components have been located such that the exit portion of the prior art fibre referred to above protrudes at least a length equal to the minimal functional arc radius, the maximal protrusion of the first exit portion according to the invention is less than half the functional arc radius as compared to the prior art component. Of course any small reduction in mounting length is favourable, however, a reduction in mounting length by half the functional arc radius is a limit where the reduction becomes truly effective as a relief on the rigid restrictions with respect to outer physical dimensions of the components. The gained millimetres can be used for other features of the components, such as the Bragg grating or the temperature-compensating structure.

In this application, the term “optical fibre” includes any fibre designed to guide light along its length. The fibre can be stripped or include a core and cladding covered by one or several layers of other materials, typically coating layers, but also layers for enhancing the optical performance or for other purposes. The term also includes fibres, which comprises portions of different or equal types of optical fibre, which have been spliced together or otherwise joined.

In this application, the term “minimal functional arc radius” shall be understood as the minimal bending radius in a point of the optical fibre. Thus, the minimal functional arc radius in a specific point is equal to the minimal functional arc radius of the type of fibre at the point in question. The minimal functional arc radius of a specific fibre type is, in turn, determined by how much that type of fibre can be bent without the risk of suffering long or short term damages due to mechanical stress becoming unacceptably high. Furthermore, optical fibres tend to increasingly leak more light the more they are bent. Thus, the acceptable amount of light leakage for the intended use of the fibre or of the component comprising the fibre imposes another limit to the minimal functional arc radius. In addition, if a specific use of the optical fibre component according to the invention demands for any other possible limitations on how much the fibre can be bent in order for the component to function properly, these limitations shall of course also be considered when determining the minimal functional arc radius as the term is to be understood in this application.

Some suppliers of optical fibres provide information regarding properties of their optical fibres with respect to bending. For other fibres, the skilled person can easily find the minimal functional arc radius by testing or through calculations.

An example of an optical fibre that can be used for the first exit portion is SMF-28e as supplied under this trademark by Corning Inc. A reasonable value for the minimal functional arc radius for this fibre is 16 mm. This value is based on data provided by the manufacturer while considering the risks of mechanical failure and optical loss levels associated with the bending process. When this fibre is used according to the invention, it can be bent away from the housing without protruding more than 8 mm.

The optical fibre according to the invention includes at least three fibre portions, i.e. a first exit portion, which in one of its ends meets an end of a first connecting portion, which, in turn, at its other end meets with a first end of a thermally compensated portion. The optical fibre can be an integral fibre, it can comprise several pieces of the same fibre type attached together, or fibres of different types can be used for the different portions of the optical fibre. It is of course also possible to use several different fibre types in one and the same portion.

According to the invention, the first exit portion has a length of about the circumference of a circle with the minimal functional arc radius, or shall be considered as if it had such a length. In embodiments where the first exit portion comprises several fibre types having different minimal functional arc radiuses and having a shorter exit portion, the length to be considered is the length corresponding to the circumference of the circle with the shortest minimal functional arc radius.

The optical fibre according to the invention further includes a portion provided with a Bragg grating in a region thereof. The Bragg grating can be provided in any suitable manner and have any suitable characteristics.

The portion with the Bragg grating is held under tension in a linear direction by a temperature-compensating structure. The portion comprising the Bragg grating is thus a thermally compensated portion. The linear direction referred to in this application is consequently defined by the axis of the thermally compensated portion of the optical fibre.

According to the invention, the fibre type of the thermally compensated portion can be selected from fibre types which are suitable with respect to the performance of the Bragg grating. For the connecting portion and the exit portion other fibre types can be selected which have shorter minimal functional arc radiuses.

The thermally compensated portion can be attached to the temperature-compensating structure in any suitable manner, for example in one discrete point only, in several discrete points, or over a continuous piece of its length. One example is to attach the fibre to the structure by using nodes formed of low temperature melting glass or epoxy. According to an embodiment of the invention, the thermally compensated portion is attached to the structure in two attachment points, one in each end of the thermally compensated portion, whereby the attachment points are spaced in the linear direction and arranged within the housing.

The temperature-compensating structure can be constructed in any suitable way in order to supply the necessary tension to the Bragg grating. The structure usually includes several elements of different metals and dimensions, such that a change in the Bragg wavelength in response to a temperature change within a defined range is cancelled, or at least substantially reduced, by the tension induced by the compensating structure. For example, the structure can include two discrete islands of elements, which are arranged symmetrical over the Bragg grating. However, the temperature-compensating structure can also include asymmetrical islands or even a continuous structure. The housing can constitute an element, which is part of the temperature-compensating structure.

The optical device according to the invention comprises a housing for mechanical protection of the Bragg grating. However, the housing can also be adapted for protection from other environmental conditions, for example moisture. To this end, the housing can be an open structure or a sealed capsule, even a hermetically sealed capsule. The housing can be arranged to hold a gas other than air, such as nitrogen or other inert gases for the purpose of making the internal atmosphere chemically inert to the materials of the inside of the housing.

The housing can have any suitable geometrical shape. Normally the housing is an elongated structure for enclosing the thermally compensated portion, at least the first connecting portion and at least a part of some element of the temperature-compensating structure. The housing can for example have an overall shape of a mathematical cylinder, i.e. a cylinder with an arbitrary, but constant, cross section. The cross section can, for example, be circular, square, rectangular, or polygonal. The housing is normally provided with end walls which can be planar or protrude in the linear direction by being for example semi-spherical.

According to the invention, the housing has a maximal extension in the linear direction from a first housing end to a second housing end. In embodiments, where the temperature-compensating structure is totally enclosed in the housing, the maximal extension in the linear direction is from an outer surface of one end wall to an outer surface of a second end wall. In embodiments, where the housing as such is part of the temperature-compensating structure or where the temperature-compensating structure protrudes from a housing wall in the linear direction, whereby the protruding portion of the temperature-compensating structure becomes part of the housing, the maximal extension in the linear direction is from a first structure end to a second protruding structure end, or, to an outer surface of a second end wall.

The housing is provided with at least a first lead-through such that the optical fibre can cross the housing wall. The fibre passes through the first lead-though from an entrance end inside the housing to an exit end outside the housing. The first lead-through can have any suitable shape and dimension. The first lead-through can be an open channel at a wall end of an open housing or a sleeve shaped element. The first lead-through can be arranged perpendicularly or angled relative the housing wall. The first lead-through can constitute a simple opening or comprise several details.

Normally, the lead-through is arranged to hold the optical fibre in a tension damping manner. If tension is imposed on the optical fibre outside the housing, i.e. to the exit portion, the tension will be absorbed by the damping at least to some extent. Preferably, only a minor amount of the tension is transferred to the thermally compensated portion. To this end, the first lead-through can comprise an elastic element for holding the optical fibre, or to be exact, an end portion of the connecting portion. The first lead-through can include a protective sleeve for mechanical protection of the first exit portion at the first lead-through exit end.

According to an embodiment of the invention, the first lead-through is located and arranged such that the first exit portion is bendable to the minimal functional arc radius without protruding in the linear direction beyond the first housing end at all. This is advantageous in that the first exit portion does not contribute at all to the mounting length of the optical fibre component. Therefore, all available space in a device where the optical fibre component is to be mounted, can be used for the main functional features of the component such as the Bragg grating and the temperature-compensating structure.

The mounting length of the optical fibre component according to this embodiment is thus determined by the maximal extension of the housing in the linear direction. If an embodiment, wherein the first exit portion is bendable to the minimal functional arc radius without protruding beyond the first housing end, further includes an elongated housing, the feature can be implemented by arranging the lead-through in a wall portion of the housing that is not as distal in the linear direction as the housing end. However, if the first lead-through is arranged such that the first exit portion exits the first lead-through substantially perpendicular to the linear direction, the first lead-through can be positioned very close to the first housing end without the first exit portion protruding beyond it when bent to the minimal functional arc radius.

According to an embodiment of the invention, the housing is an elongated cover element having a longitudinal extension in the linear direction, and comprising at least one longitudinal wall and two end walls, the first lead-through is located in the longitudinal wall. The first lead-through can in addition be such arranged by being such angled relative the linear direction, that the first exit portion is bendable to the minimal functional arc radius without protruding beyond the first housing end at all. The same can be achieved by arranging the first lead-through in a dome-shaped end wall.

Normally, the first connecting portion of the optical fibre is curved in order to meet the first lead-through. The first connecting portion can follow a curve having a constant or a varying arc radius, and also include linear portions. Consequently, the optical fibre component can be made more compact by bending also the connecting portion. The curvature of the first connecting portion can start at the attachment point.

According to an embodiment of the invention, the first lead-through is located closer to the Bragg grating than what would be necessary for achieving the condition that the first exit portion, while having the prescribed length, is bendable to the minimal functional arc radius without protruding in the linear direction beyond the first housing end. This can be implemented by bending the connecting portion correspondingly. However, the first lead-through can not be located closer to Bragg grating than that the connecting portion can reach the first lead-through without being bent more than to its minimal functional arc radius. This embodiment is advantageous in that an even more compact component is obtained, and in that the position of the first lead-through can be selected to better fit in the application where the optical component according to the invention is to be installed. Another advantage is that the length of the first lead-through does not add to the total mounting length of the optical fibre component. Thus, a designer is free to use for example long damping elements or protection sleeves. Good results are achieved when the first connecting portion is bent to twice the minimal functional arc radius, because then the curvature of the first connecting portion contributes to the compactness of the optical fibre component while at the same time the first connecting portion is not bent to near its limit.

According to an embodiment of the invention, the thermally compensated portion of the optical fibre comprises a fibre type, which is suitable for forming Bragg gratings, for example a fibre with the core doped with germanium and/or boron.

According to at least one embodiment of the invention, the housing is further provided with a second lead-through. Furthermore, the optical fibre includes a second connecting portion, which extends from a second end of the thermally compensated portion to and through the second lead-through, and a second exit portion, which extends from a lead-through exit end of the second connecting portion. The second lead-through is constructed and arranged corresponding to the first lead-through according to any of its embodiments, the second connecting portion is constructed and arranged corresponding to the first connecting portion according to any of its embodiments, and the second exit portion is constructed and arranged corresponding to the first exit portion according to any of its embodiments. Furthermore, the second lead-through, the second connecting portion, and the second exit portion are related to the second housing end in a manner corresponding to the relation of the first lead-through, the first connecting portion, and the first exit portion to the first housing end according to any of the corresponding embodiments of the invention.

In such embodiments of the invention, the optical fibre component is divided into two sides, i.e. a first side with all “first” components, and a second side with all “second” components. The two sides can be symmetrical over the Bragg grating. However, the components of the two sides can also be constructed differently within the definition of the features according to the invention. For example, the first and second lead-throughs can be located asymmetrical over the Bragg grating in the housing, the direction in which the first and second exit portion leaves the respective lead-through can differ, and/or the curve of the first and second connecting portion can differ.

### BRIEF DESCRIPTION OF THE DRAWINGS

The invention may be performed in many various ways, and by way of example only, embodiments thereof will now be described in detail with reference being made to the accompanying drawings, in which

FIG. 1 is a schematic, longitudinal sectional view of an optical fibre component according to the prior art;

FIG. 2 is a schematic, longitudinal sectional view of an optical fibre component according to a first embodiment of the invention;

FIG. 3 is a schematic, longitudinal sectional view of an optical fibre component according to a second embodiment of the invention;

FIG. 4 is a schematic, longitudinal sectional view of an optical fibre component according to a third embodiment of the invention;

FIG. 5 is a schematic, longitudinal sectional view of an optical fibre component according to a fourth embodiment of the invention; and

FIG. 6 is a schematic, longitudinal sectional view of an optical fibre component according to a fifth embodiment of the invention.

### DETAILED DESCRIPTION OF PREFERRED EMBODIMENTS OF THE INVENTION

In FIG. 2, an optical fibre component according to a first embodiment of the invention is shown. The component comprises an optical fibre 1, which has a minimal functional arc radius in each point thereof. The optical fibre includes a portion 2, in which a Bragg grating is provided. The optical fibre furthermore includes a first connecting portion 3 and a second connecting portion 4. Finally, the optical fibre includes a first exit portion 5 and a second exit portion 6. The optical fibre component is divided into a first side and a second side over the Bragg grating.

In this embodiment, the portion 2 with the Bragg grating is a germanium doped fibre having less favourable minimum functional arc radius due to mechanical damage induced by the fibre handling in the grating manufacturing process. The first and second connecting portions 3, 4 are of a fibre type that is supplied under the trademark SMF-28e by Corning having, for the example use, a minimal functional arc radius of 16 mm, and the first and the second exit portions 5, 6 are of the fibre type SMF-28e manufactured by Corning having, for the example use, a minimal functional arc radius of 16 mm. Each of the portions 3, 4, 5, 6 comprises said fibre type only.

The optical fibre component further comprises a housing 10 for mechanical protection of the Bragg grating. The housing 10 is an elongated cover element in the form of cylindrical capsule having a circular cross section. The housing 10 has a first circular end wall 11 and a second circular end wall 12. The portion 2 with the Bragg grating and the first and second connecting portions 3, 4 are enclosed in the housing 10.

The optical fibre according to the first embodiment comprises further a temperature-compensating structure 7, which is enclosed in the housing 10. The temperature-compensating structure comprises a base element 8 of a material, which has a low coefficient of thermal expansion (CTE). In this embodiment, the material of the base is a material, which is distributed under the trademark Invar. The temperature-compensating structure also includes two compensating members 9, which are attached to the base 8 at each end thereof. The compensating members 9 are of a material having a high CTE such as aluminium or brass.

The portion 2 of the optical fibre with the Bragg grating is held under tension in a linear direction by the temperature-compensating structure 7, whereby the Bragg grating is athermalized. The portion 2, which comprises the Bragg grating, is thus a thermally compensated portion. The thermally compensated portion 2 is attached to the temperature-compensating structure 7 in a first attachment point 15 and in a second attachment point 16, which attachment points 15, 16 are located spaced in the linear direction and constitute discrete epoxy nodes. The optical fibre 1 has no direct contact with temperature-compensating structure 7. The extension of the thermally compensated portion 2 defines a linear direction.

The housing 10 has its longitudinal extension in the linear direction, and thus a maximal extension 18 in the linear direction from an outer surface of the first end wall 11 to the outer surface of the second end wall 12.

The housing 10 is provided with a first lead-through 13 and a second lead-through 14, each having an exit end outside the housing 10 and an entrance end located inside the housing 10.

The first connecting portion 3 extends from a first end of the thermally compensated portion 2 to and through the first lead-through 13. The first exit portion 5 extends from a lead-through exit end of the first connecting portion 3. The second connecting portion 4 and the second exit portion 6 are arranged correspondingly on the second side of the optical fibre component.

In the embodiment of FIG. 2, the first and second connecting portions extend from the respective ends 15, 16 of the thermally compensated portion 2 in the linear direction before they are bent to the minimal functional arc radius in order to meet with the respective lead-through 13, 14.

The first lead-through 13 of this embodiment is a sleeve-like element. Inside the sleeve-like element, a strain-relieving, damping element in the form of an elastic bushing (not shown) is arranged. The elastic bushing holds an exit end portion of the first connecting portion 3. With this arrangement it is achieved that strain applied to the first exit portion is absorbed or at least damped by the elastic bushing, whereby no or only a minor amount is transferred to the connecting portion. Consequently, the first attachment point 15 is spared from stress and the Bragg grating is protected.

The first lead-through 13 further includes a protective sleeve (not shown) for mechanical protection of the first exit portion 5.

The construction of the second lead-through 14 corresponds to that of the first lead-through 13, and further explanation thereof is thus dispensed with.

The first exit portion 3 of this embodiment is rather short, such that, for the purposes of this invention, an extended first exit portion 3 having a length equal to the minimal functional arc radius of the first exit portion is considered (as indicated by the dashed line). The first lead-through 13 is such positioned in the first end wall 11 and has such an angle relative the linear direction, that, when the extended first exit portion 3 is bent to the minimal functional arc radius r (16 mm), the point thereon that is most distal in the linear direction protrudes only a few millimetres from the housing end, in this case the outer surface of end wall 11. This protrusion is less than half the minimal functional arc radius r. Consequently, the optical fibre component has a minimal mounting length 17 of two times the protrusion 19 plus the maximal extension 18 of the housing.

The corresponding is also true mutatis mutandis for the second side of the optical fibre component, and thus not explained further.

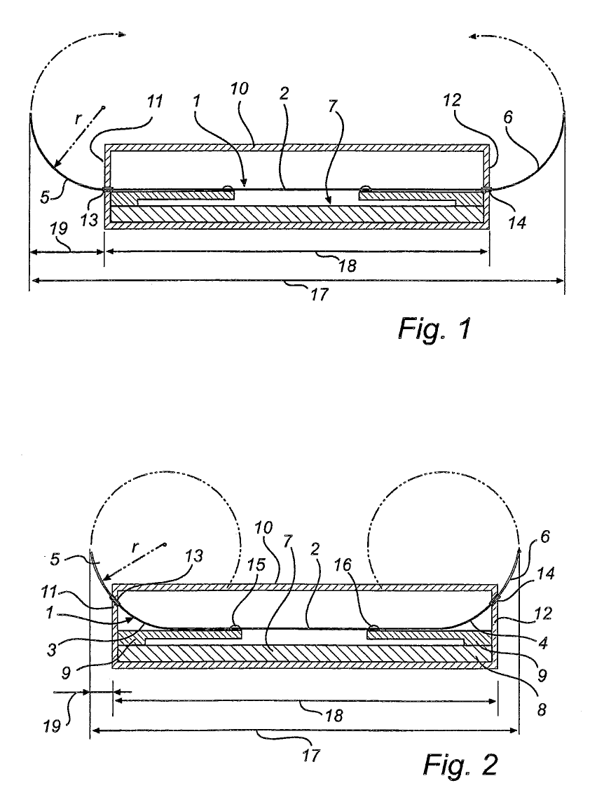

In FIG. 1, a prior art optical fibre component is shown, wherein corresponding details are given the same reference numerals as in the explained first embodiment of the optical fibre component according to FIG. 2. In the prior art component, the lead-throughs 13, 14 are arranged in the linear direction in the end walls 11, 12. Thus, the exit portions 5, 6 leave the housing 10 through the lead-throughs 13, 14 in the linear direction. The same type of fibre is used for the first and second exit portions 5, 6, as in the first embodiment of the invention, wherein they all have the same minimal functional bending radius. If duly extended exit portions 5, 6 are bent to their minimal functional arc radius in the prior art component, the point thereon that is most distal in the linear direction protrudes a distance equal to the minimal functional arc radius from the housing end, in this case the outer surface of end wall 11. Consequently, this protrusion (19) is more than half the minimal functional arc radius r.

If the optical fibre component of the first embodiment according to FIG. 2 is compared with the prior art optical fibre component according to FIG. 1, it is clear that the prior art component has a considerably longer minimal mounting length 17, although the maximal extension (18) of the housing 10 is equal to that of the first embodiment according to the invention. Thus, the reduction in the minimal mounting length 17, which can be obtained with an optical fibre component according to the invention, is achieved by the inventive arrangement of the lead-throughs.

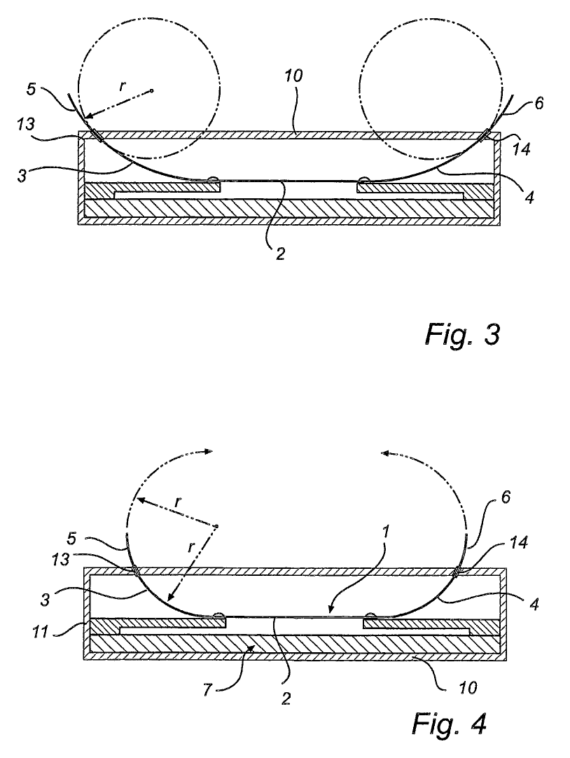

In the FIGS. 3-6, further embodiments of the invention are shown, wherein corresponding details are given the same reference numerals as in the explained first embodiment of the optical fibre component according to FIG. 2. Furthermore, the additional embodiments are only explained to the extent that they differ from the first embodiment explained above.

In FIG. 3, a second embodiment of the invention is shown, which differs from the embodiment according to FIG. 2 in that the first and second connecting portions 3, 4 are bent to a constant radius which is longer than the minimal functional arc radius. Due to this longer bending radius, some slack is introduced to the connecting portion, which is advantageous with regard to limiting the risk of strain being transferred to the thermally compensated portion 2, while at the same time the mechanical stress due to maximal bending is reduced.

The first and second lead-throughs 13, 14 are located, spaced a small distance from the respective housing end, in the longitudinal, cylindrical wall of the housing. The first and the second lead-throughs each are angled relative the linear direction. As is clear from FIG. 3, the position and angle of the first and the second lead-throughs are such arranged that the first and second exit portions 5, 6 are bendable to the minimal functional arc radius r without protruding in the linear direction beyond the respective housing ends. This is indicated by the dashed line in FIG. 3, wherein the exit portion is considered as if it had a length of the circumference of a circle with the minimal functional arc radius r.

In the third embodiment shown in FIG. 4, the first and the second connecting portions 3, 4 are bent to a circle curve having the minimal functional arc radius over substantially their total length. Thereby, the first and the second lead-throughs 13, 14 are located in the longitudinal, cylindrical housing wall as far as possible from the respective housing end in the linear direction. Thereby, an optical fibre component which is especially compact in the linear direction is achieved.

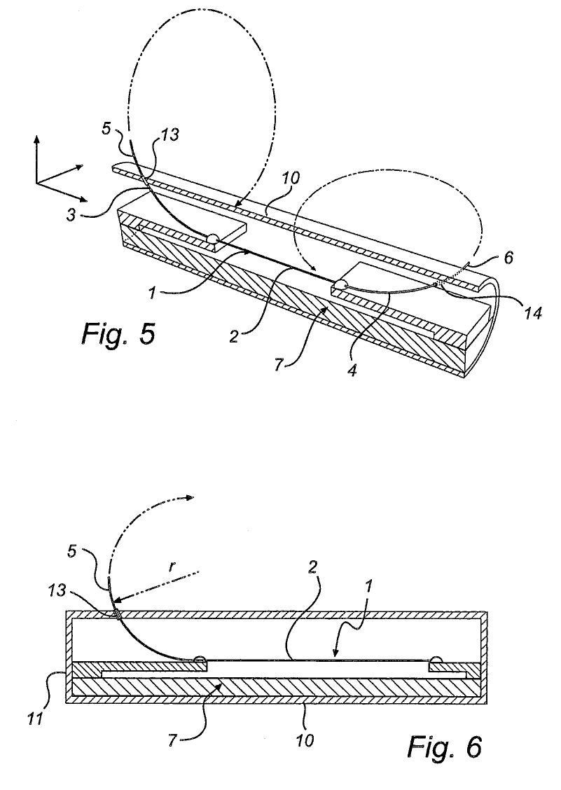

In FIG. 5, a fourth embodiment of the optical fibre component according to the invention is shown. This embodiment corresponds substantially to the fourth embodiment shown in FIG. 4, but differs in that the first and the second connecting portions 3, 4 are bent in different planes. The first connecting portion 3 is bent to its minimal functional arc radius over substantially its total length in an xz-plane, whereas the second connecting portion 4 is bent to its minimal functional arc radius over substantially its total length in an xy-plane. Consequently, this fourth embodiment of the invention is an example of an embodiment, where the first and the second sides of the optical fibre component are not symmetrical.

In FIG. 6, a fifth embodiment of the optical fibre component is shown, which comprises only a first connecting portion 3, a first exit portion 5 and first lead-through 13. The temperature-compensating structure 7 is correspondingly adapted, wherein the two compensating members 9 are asymmetrically constructed. Apart therefrom, the fifth embodiment corresponds to the first side of the fourth embodiment, which is described with reference to FIG. 4 above.

Thus, the present invention can be put into practice in many different embodiments. In addition to the embodiments shown in the Figures, it is for example also possible to arrange the first connecting portion 3 and any second connecting portion 4 with a curvature that varies over their respective lengths, or the linear part can be made shorter than that of the first embodiment shown in FIG. 2. The embodiments can also be combined, such that one embodiment is retrieved in the first side of the optical fibre component and another in the second side of the optical fibre component. Of course, any embodiment can be realized also in a component having one exit portion only in correspondence to the fifth embodiment of FIG. 6.

1. An optical fibre component, comprising
an optical fibre, which has a minimal functional arc radius in each point thereof, and which includes a thermally compensated portion, and a Bragg grating provided in a region of the thermally compensated portion,
a temperature-compensating structure, which holds the thermally compensated portion of the optical fibre under tension in a linear direction for athermalizing the Bragg grating,
a housing for mechanical protection of the Bragg grating, which is provided with at least a first lead-through, and which housing has a maximal extension in the linear direction from a first housing end to a second housing end, wherein
the first lead-through has an exit end located outside the housing and an entrance end located inside the housing,
the optical fibre furthermore includes at least a first connecting portion, which extends from a first end of the thermally compensated portion to and through the first lead-through, and at least a first exit portion which extends from a lead-through exit end of the first connecting portion, and wherein
the first lead-through is located and arranged such that the first exit portion is bendable to the minimal functional arc radius without protruding more than half the minimal functional arc radius in the linear direction beyond the first housing, also when a shorter exit portion is extended to a length equal to the circumference of a circle with the minimal functional arc radius.

2. The optical fibre component according to claim 1, wherein the first lead-through is located and arranged such that the first exit portion is bendable to the minimal functional arc radius without protruding in the linear direction beyond the first housing end.

3. The optical fibre component according to claim 1, wherein the housing is an elongated cover element having a longitudinal extension in the linear direction, the cover element has a longitudinal wall with an overall extension in the linear direction, and wherein the first lead-through is located in the longitudinal wall.

4. The optical fibre component according to claim 3, wherein the housing is a capsule in the form of a mathematical cylinder and the first lead-through is located in a cylinder wall thereof.

5. The optical fibre component according to claim 1, wherein the first lead-through is located and arranged such that the first connecting portion, over substantially the total length, is bent to an arc radius, which is shorter than 2× the minimal functional arc radius and longer than the minimal functional arc radius.

6. The optical fibre component according to claim 1, wherein the first lead-through is located and arranged such that the first connecting portion has a curve extending substantially in one plane only.

7. The optical fibre component according to claim 1, wherein the thermally compensated portion of the optical fibre comprises a fibre type, which is suitable for forming Bragg gratings, and wherein the first connecting portion and/or the first exit portion comprises a fibre type, which has a minimal functional arc radius shorter than 20 MM.

8. The optical fibre component according to claim 1, wherein the temperature-compensating structure is a part of the housing.

9. The optical fibre component according to claim 1, wherein
the housing further is provided with a second lead-through,
the optical fibre furthermore includes a second connecting portion, which extends from a second end of the thermally compensated portion to and through the second lead-through, and a second exit portion, which extends from a lead-through exit end of the second connecting portion, and wherein,
the second lead-through, the second connecting portion and the second exit portion are constructed, arranged and related to the second housing end corresponding to the first lead-through, the first connecting portion and the first exit portion, respectively, and their respective relations to the first housing end.

10. The optical fibre component according to claim 2, wherein the housing is an elongated cover element having a longitudinal extension in the linear direction, the cover element has a longitudinal wall with an overall extension in the linear direction, and wherein the first lead-through is located in the longitudinal wall.

11. The optical fibre component according to claim 2, wherein the first lead-through is located and arranged such that the first connecting portion, over substantially the total length, is bent to an arc radius, which is shorter than 2× the minimal functional arc radius and longer than the minimal functional arc radius.

12. The optical fibre component according to claim 3, wherein the first lead-through is located and arranged such that the first connecting portion, over substantially the total length, is bent to an arc radius, which is shorter than 2× the minimal functional arc radius and longer than the minimal functional arc radius.

13. The optical fibre component according to claim 4, wherein the first lead-through is located and arranged such that the first connecting portion, over substantially the total length, is bent to an arc radius, which is shorter than 2× the minimal functional arc radius and longer than the minimal functional arc radius.

14. The optical fibre component according to claim 2, wherein the first lead-through is located and arranged such that the first connecting portion has a curve extending substantially in one plane only.

15. The optical fibre component according to claim 3, wherein the first lead-through is located and arranged such that the first connecting portion has a curve extending substantially in one plane only.

16. The optical fibre component according to claim 4, wherein the first lead-through is located and arranged such that the first connecting portion has a curve extending substantially in one plane only.

17. The optical fibre component according to claim 5, wherein the first lead-through is located and arranged such that the first connecting portion has a curve extending substantially in one plane only.

18. The optical fibre component according to claim 2, wherein the thermally compensated portion of the optical fibre comprises a fibre type, which is suitable for forming Bragg gratings, and wherein the first connecting portion and/or the first exit portion comprises a fibre type, which has a minimal functional arc radius shorter than 20 mm.

19. The optical fibre component according to claim 3, wherein the thermally compensated portion of the optical fibre comprises a fibre type, which is suitable for forming Bragg gratings, and wherein the first connecting portion and/or the first exit portion comprises a fibre type, which has a minimal functional are radius shorter than 20 mm.

20. The optical fibre component according to claim 4, wherein the thermally compensated portion of the optical fibre comprises a fibre type, which is suitable for forming Bragg gratings, and wherein the first connecting portion and/or the first exit portion comprises a fibre type, which has a minimal functional arc radius shorter than 20 mm.
